(19) United States
(12) Patent Application Publication
(10) Pub. No.: US 2007/0079307 A1
(43) Pub. Date: Apr. 5, 2007

(54) Virtual machine based network carriers

(76) Inventors: Puneet Dhawan, Austin, TX (US); Timothy Abels, Pflugerville, TX (US)

Correspondence Address: HAMILTON & TERRILE, LLP, P.O. BOX 203518, AUSTIN, TX, 78720, US

(21) Appl. No.: 11/239,750

(22) Filed: Sep. 30, 2005

(51) Int. Cl. G06F 9/455

(52) U.S. Cl. 718/1

(57) ABSTRACT

A system and method is disclosed for the secure transfer of data by carrier virtual machines between participating physical hosts through a virtual network (VNET) implemented on one or more internal and/or external networks. The method of the invention can provide additional security controls, comprising parameters that may include, but are not limited to, time-to-live (TTL), access control lists (ACLs), usage policies, directory roles, etc. Additionally, access to one or more of a plurality of carrier virtual machine payloads by security groups, individual access, subdivided individual access, and MIME-like subdivision of a VM-encapsulated payload may be controlled, thereby providing the carrier VM the ability to carry many secured payloads. In addition, VM packets, a group of packets, a single VM, or subpackets within a VM between network endpoints, or at a predetermined intermediary network point, may be quarantined to realize further security. Individual or combinations of these functionalities on carrier virtual machines, and by extension, application and/or one or more sets of secure data may be implemented.

### BACKGROUND OF THE INVENTION

1. Field of the Invention

The present invention relates in general to the field of information handling systems and, more specifically, to the flexible and secure transfer of packets by carrier virtual machines.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, an how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems.

Information handling systems continue to improve in their ability to generate and manage information. Concurrently, networks are growing in size, access to them is becoming ubiquitous, and their cost is declining. However, as networks become a commodity resource, the security and manageability of the data they transport can become an issue. Accordingly, different approaches have been employed to securely manage highly sensitive data from malicious attack/unauthorized access or usage once it leaves a sender's machine.

One of the challenges in secure computing and network environments is hiding the identities of the originator and intended recipient of highly sensitive data. Hackers continue to use creative approaches to monitor network activity, especially in identifying high profile candidate IP/MAC addresses, and high value data conduits or paths within a network. Various techniques can be used against these malicious monitors to protect against exposure of sensitive data and the identity of systems involved, including firewalls, data encryption, traffic camouflaging, etc. However, these methods are not fool proof and they each have characteristics that can result in attendant issues.

Typical IT environments can consist of numerous independent and distributed servers, networks, and storage devices that can be virtualized into a single, centrally managed pool of resources by virtualizing server, network, and storage resources. These virtual environments also enable sensitive data/applications to be securely shared between both physical and virtual machines.

Virtual machines are generally implemented through the use of a virtual machine monitor (VMM), which can run on each physical server, which in turn can run multiple virtual machines and abstract each virtual machine's view of its associated storage and networks. Accordingly, each physical server can support a predetermined number of virtual machines and runs a management OS in a separate virtual machine that participates in the management and operation of the server, network, and storage infrastructure. These VMM-managed resources can include processors, memory, network bandwidth, and I/O bandwidth, all aggregated into a single, unified resource pool.

By managing resources available within the unified pool, a VMM can combine and/or allocate virtual machines, thereby reducing processing and resource demands on individual physical servers. In addition to managing resource allocation, virtual machine monitors typically provide the services to create, quiesce, and destroy virtual machines. These services, combined with the encapsulation of a virtual machine's software state, can enable a VMM to map and remap virtual machines to available physical resources, thereby enabling migration of virtual machines from one physical server to another.

Server-based storage virtualization generally aggregates storage resources that are attached to a server. Typically, a virtual volume manager (VVM) will create Virtual Storage Devices (VSDs) from these resources, which may be located in directly attached storage, or network attached storage (NAS) such as a storage area network (SAN). A virtual machine manager, through VSDs, can access these storage devices, including storage directly attached to other servers.

Currently, virtual machine migration is generally implemented on physical servers that share a common pool of data storage resources, with the location of data in the storage pool invisible to virtual machines and applications. When a virtual machine migrates to other nodes a virtual volume manager, working in concert with a virtual machine manager, can provide the necessary routing and redirection functionality to transport data stored in VSDs across SAN and LAN fabrics.

When a virtual machine is live migrated (migrated to another physical host while it is running), its associated VSDs are migrated along with it, but only the VSD's access points migrate and no physical data is moved. This is needed as VSDs can be of big size and pose a challenge for a quick migration process of the virtual machine across physical hosts. Furthermore, data can be moved transparently between physical devices while allowing a virtual machine to continue accessing VSD data while it is in transit. Migrating VSDs across physical hosts can be performed by using different techniques like pre-mirroring, Copy on Write (COW) etc. With decreasing bandwidth costs and increasing interconnect speed; penalty due to this process will not be huge. Virtual machines can be cold migrated across a LAN or a WAN by shutting them down and migrating the VSDs and configuration files to the target physical system. Having a light weight OS and keeping the VSD size to minimum required, the time taken for cold migration can be reduced.

Network virtualization can give users the impression of having their own virtual private local area network (LAN). Commonly known as a VNET, these virtualized networks can typically use any media access control (MAC) or IP address available within a physical network. Generally, a VNET is a virtual private network (VPN) that implements a virtual local area network (VLAN) that in turn is implemented on a physical network such as a Local Area Network (LAN), a Wide Area Network (WAN) such as the Internet or a corporate intranet, or a combination of public and/or private network technologies and protocols that may be required to transport data packets between one or more information handling systems.

A VNET is typically established at layer 2 of the OSI network model. Through the use of layer 2 tunneling and by translating between physical and virtual network addresses, a VNET can create the illusion of a local area network, even when physical network resources are spread over a wide area. Since a VNET is established at layer 2, a virtual machine can be migrated from site to site without changing its presence, as it keeps the same media access control (MAC) and IP addresses, network routes, etc. Furthermore, since VNETs are decoupled from the underlying network topology, they are able to maintain network connectivity during virtual machine migration.

Additionally, VNETs can provide security comparable to a hardware-based VLAN through the use or the IPsec Encapsulated Security Payload protocol. IPsec can be used to encapsulate VNET EtherIP packets to provide message authentication, thereby ensuring that only authorized entities within the virtual network can send data. In addition, IPsec can employ encryption to ensure that only the intended recipient can read data conveyed by IPsec packets.

While each of the approaches described hereinabove provides some level of flexibility and security, there is a need for an improved way of securely managing data and processes across physical hosts.

### SUMMARY OF THE INVENTION

In accordance with the present invention, a system and method is disclosed for virtual machines implemented as carriers of a payload that may include applications, data, another virtual machine etc. In various embodiments of the invention, virtual machines carrying the payload can be routed between physical hosts, based on set policies providing a secure, manageable and highly flexible environment for data and process management. Those of skill in the art will realize that many variations and implementations of such embodiments are possible.

When coupled with encryption, the system and method of the invention described in more detail hereinbelow can provide a secure environment for data/application management among multiple physical hosts. Data to be transported is first encrypted and then encapsulated by a carrier virtual machine at each stage of the migration process among the physical hosts involved. To implement various embodiments of the invention requires an infrastructure, such as that provided by VMware or the Xen open source environment, to create and manage virtual machines.

In an embodiment of the invention, a user specifies which payload should be secured and needs to be sent to particular hosts. A special carrier virtual machine (VM) is created that can transfer the payload to its predetermined destination host(s). VM migration and/or routing tables are built in the carrier VM, which determine which hosts will be participating. A connection is made to the target host(s) to accept the request for transferring the virtual machine. The specified payload is (or can be encrypted and then) encapsulated in a carrier VM. Typically, a “time-to-live” attribute is also set for VM. If the VM fails to migrate to its next hop/does not completed intended task at the host in the specified time, it can notify the sender then destroy itself and hence the payload it contains, send a request to the originating host for a time-to-live extension if network is congested, request a reroute due to high traffic on a predetermined route or access policies etc, or other predetermined actions.

The carrier virtual machine is then migrated to the next participating physical host. Using the policy based Autorun Engine; necessary actions can be taken at each host. Examples may include transferring of data to the physical host or to a virtual machine in the physical host through a virtual network, to any other physical or virtual machine, a payload application gathering data or performing some maintenance on the physical or virtual machine, destroy itself if VM is on an unidentifiable host, change network interface properties like set new MAC address etc. In an embodiment of the invention, payload is transferred to a next carrier virtual machine through a virtual network implemented between the originating carrier VM and a carrier VM established on the participating physical host next to initiator in the migration path. Once the secure payload has been transferred to the next carrier VM, the virtual network, can be destroyed to provide an additional level of security. In an embodiment of the invention, the payload is transferred to the next carrier virtual machine through “hot cloning.” In this embodiment, as the carrier VM migrates from one physical host to another, a clone of the VM is created in the next participating physical host in the migration path. This hot cloning process may use copy on write (COW), which can be implemented as completion of the cloning operation before the next carrier virtual machine transfer is initiated, or beginning the next virtual machine carrier transfer before the cloning operation is complete. Once the secure data has been transferred to the next carrier VM, the virtual network can be destroyed to provide an additional level of security.

Once the originating carrier virtual machine has completed its migration to the next participating physical host it can be destroyed on the originating participating physical host. The migrated virtual machine now becomes a carrier virtual machine if migration to additional participating physical hosts is required. At each physical host the carrier virtual machine completes its assigned task and can notify the management application about the status of its task. In case of failure, necessary steps can be taken based on set policies and events (e.g. type of failure). Those of skill in the art will understand that many such embodiments and variations of the invention are possible, including but not limited to those described hereinabove, which are by no means all inclusive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the method and apparatus of the present invention.

FIG. 2 is a generalized illustration of an IP datagram that can be used to implement the system and method of the present invention.

FIG. 3 is a generalized illustration of a TCP/IP network that can be used to implement the system and method of the present invention.

FIG. 4 is a generalized illustration of a TCP/IP network that can be used to implement the system and method of the present invention with carrier virtual machines.

FIG. 5a illustrates one embodiment of a carrier virtual machine to implement the system and method of the present invention.

FIG. 5b illustrates one embodiment of a plurality of carrier virtual machines to implement the system and method of the present invention.

FIG. 5c illustrates one embodiment of a carrier virtual machine encapsulating a plurality of applications and/or secure sets of data to implement the system and method of the present invention.

FIG. 5d illustrates one embodiment of a carrier virtual machine encapsulating a single carrier virtual machine and/or a plurality of secure sets of data to implement the system and method of the present invention.

FIG. 6a illustrates one embodiment of a carrier virtual machine using shared resources comprising storage area network to implement the system and method of the present invention.

FIG. 6b illustrates one embodiment of a carrier virtual machine using a virtual network (VNET) to implement the system and method of the present invention.

FIG. 6c illustrates one embodiment of a carrier virtual machine using multiple network hops across a virtual network (VNET) to implement the system and method of the present invention.

FIG. 6d illustrates one embodiment of a carrier virtual machine using “hot cloning” at multiple network hops across a virtual network (VNET) to implement the system and method of the present invention.

### DETAILED DESCRIPTION

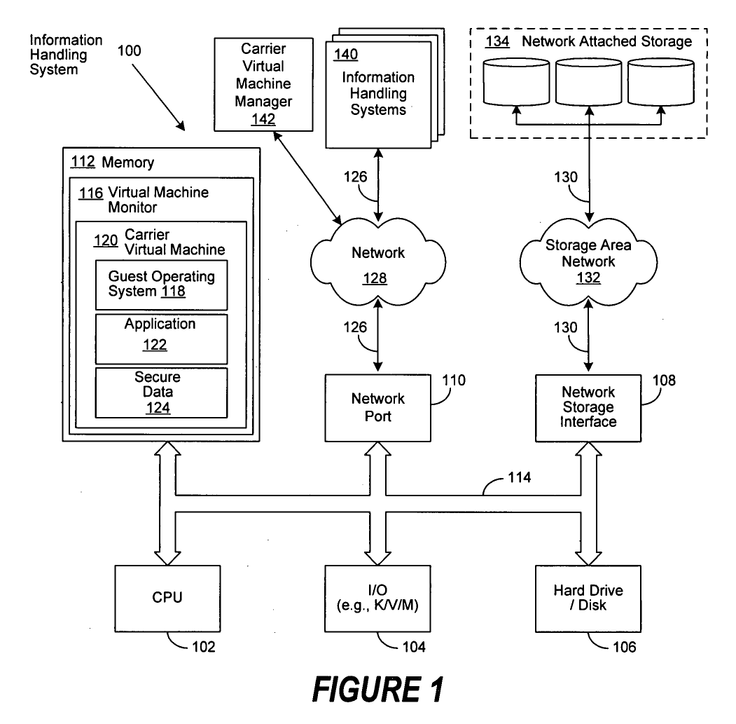

FIG. 1 is a generalized illustration of an information handling system 100 that can be used to implement the system and method of the present invention. The information handling system includes a processor (e.g., central processor unit or “CPU”) 102, input/output (I/O) devices 104, such as a display, a keyboard, a mouse, and associated controllers, a hard disk drive 106, network storage interface 108 to access network attached disk drives and other memory devices, and various other subsystems (e.g., a network port) 110, and system memory 112, all interconnected via one or more buses 114. Virtual machine monitor 116 resides in system memory 112 and in one embodiment of the invention supports an implementation of a guest operating system 118 which is utilized by the present invention for implementation of a carrier virtual machine 120, which in turn can interact with application 122 and/or secure data 124.

In an embodiment of the present invention, information handling system 100 communicates through network port 110, network connection 126, and a private (e.g., secured corporate network), public (e.g., the Internet), or hybrid (e.g., a private Intranet implemented on the public Internet) network 128 which can be but is not limited to, a local area network (LAN), a wide area network (WAN), a virtual network (VNET), or any combination of communication technologies and/or protocols that may be required to interact with one or more information handling systems 140. A virtual machine carrier manager 142 is operable to manage virtual machine packets and to implement routing and policy management for the virtual machines. In an implementation of an embodiment of the invention, information handling system 100 accesses common data through network storage interface 108, which couples to storage area network 132 through a suitable storage peripheral connection 130, such as but not limited to fiber channel, High-Performance Peripheral Interface (HIPPI), etc. to Storage area network 132, which may include any instrumentality or aggregate of instrumentalities capable of storing data, such as but not limited to hard disks, RAID arrays, optical disk drives, tape drives, etc.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

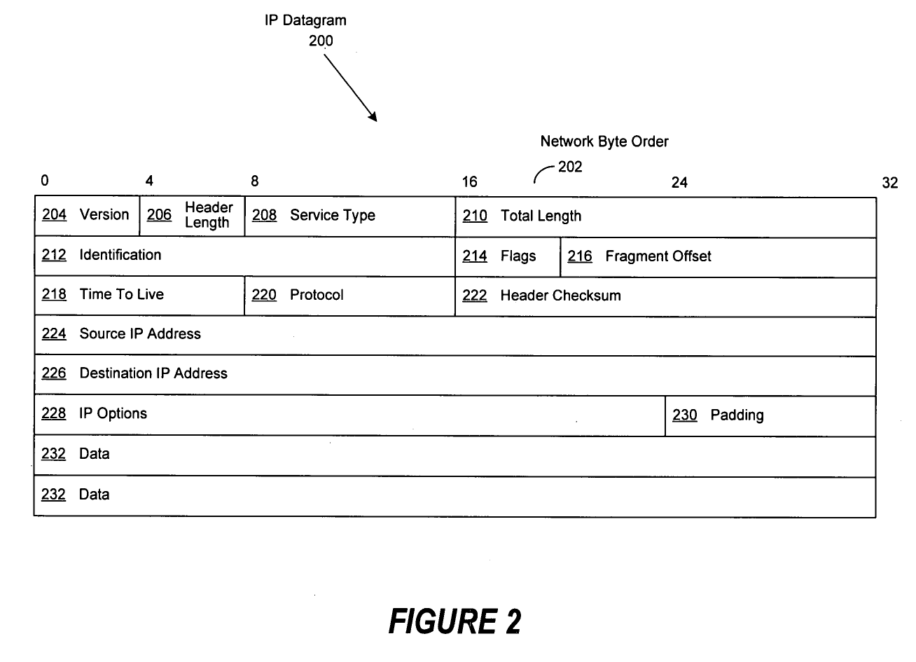

FIG. 2 is a generalized illustration of an IP datagram 200 that can be used to implement the system and method of the present invention. Those of skill in the art will be familiar with the construction of a typical IP datagram 200 comprising a connectionless datagram delivery service that relies upon upper layer protocols (e.g., TCP, UDP) to provide reliable delivery of the datagram. IP datagram 200 comprises an IP header followed by a variable-length data 232, which are transmitted in network byte order 202 (i.e., bits 0-7 first, then bits 8-15, 16-23, and 24-31). IP datagram header comprises version field 204 set to the current version of the IP protocol implemented, IP header length field 206 comprising the number of 32 bit words forming the header, type of service field 208 set to indicate the IP datagram's requested network quality of service, total length field 210 indicating the IP datagram's combined length of the header, identification field 212 which uniquely identifies the IP packet, and variable data, and flags field 214 used to control whether routers are allowed to fragment the IP packet. IP datagram header further comprises fragment offset field 216 used by routers when fragmenting an IP packet, time to live field 218 specifying the maximum number of network hops the IP packet may be routed, protocol field 220 indicating the type of transport packet being carried (e.g., ICMP, TCP, UDP), header checksum field 222 used to detect processing errors when the IP packet is being processed by a router, source IP address field 224 comprising the originating IP address of the datagram, destination IP address field 226 comprising the destination IP address of the datagram, IP options field 228 for optional purposes, and padding field 230 which may be used in Ethernet implementations to make equally sized IP packets.

In the present invention, a virtual machine monitor 116 sets the contents of IP datagram header fields, including but not limited to, service type 208, time to live 218 and destination IP address 226. In an implementation of one embodiment of the invention, a participating physical host can receive a carrier virtual machine and set the destination IP address 226 to forward the carrier virtual machine to the destination IP address of the next for the next participating physical host. This process can be repeated to implement a flexible, yet secure, carrier virtual machine routing path over one or more networks.

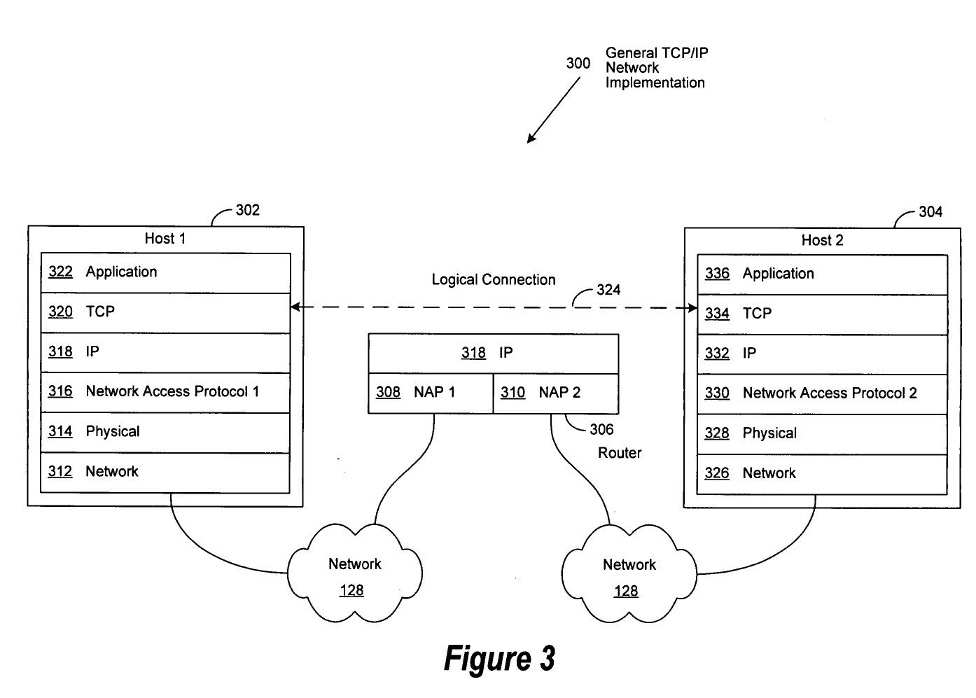

FIG. 3 is a generalized illustration of a TCP/IP network 300 that can be used to implement the system and method of the present invention. In FIG. 3, participating physical host 302 is coupled to participating physical host 304 through network 128, generally comprised of routers 306 comprising network access port ‘1’ 308, network access port ‘2’ 306, and IP protocol 318. Participating physical host ‘1’ 302 comprises communication functionality, such as a multi-layer communications protocol stack, which may be comprised of a network layer 312, physical layer 314, network access protocol ‘1’ 316, IP layer 318, TCP layer 320 and application layer 322. Participating physical host ‘2’ 304 similarly comprises communication functionality, such as a multi-layer communications protocol stack, which may be comprised of a network layer 326, physical layer 328, network access protocol ‘2’ 330, IP layer 332, TCP layer 320 and application layer 322. Note that network access protocol ‘1’ 316 on participating physical host ‘1’ 302 may be different than network access protocol ‘2’ 330 on participating physical host ‘2’ 304. Those of skill in the art will understand since a virtual machine monitor 116 can abstract the underlying hardware layer (e.g., CPU, memory, I/O, etc.) as well as encapsulating the operating state of the machine as described in more detail herein, thereby allowing differing network access protocols 316, 330 to be implemented on participating physical hosts 302, 304. Those of skill in the art will likewise be aware that a logical connection 324 can be established between the respective multi-layer communication protocol stacks of participating physical host 302 and participating physical host 304 through a TCP 320, 334 protocol session.

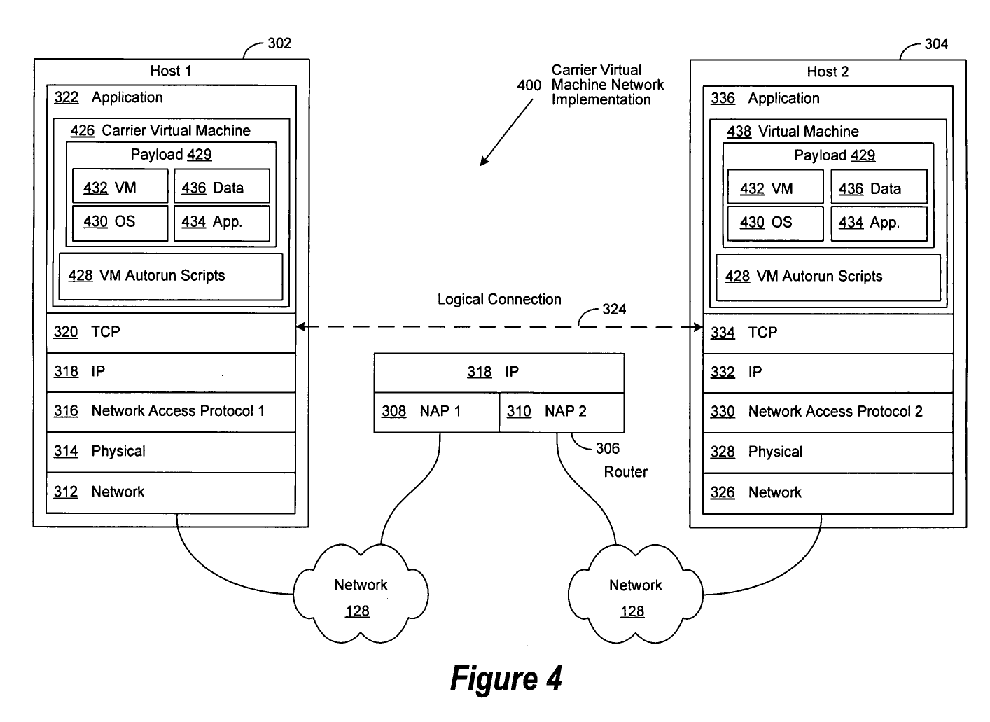

FIG. 4 is a generalized illustration of a TCP/IP network 300 that can be used to implement the system and method of the present invention with carrier virtual machines 426, 438. In FIG. 4, participating physical host 302 is coupled to participating physical host 304 through network 128, as described in more detail hereinabove.

In an embodiment of the invention, application 322 of participating physical host ‘1’ 310 comprises carrier virtual machine 426 comprising, but not limited to, virtual machine autorun scripts 428, and a payload 429 that includes operating systems 430, other virtual machines 432, applications 434, and data 436.

In this embodiment of the invention, carrier virtual machine 426 is migrated from participating physical host 302 using a multi-layer communications protocol stack as described in more detail herein, through network 128 to router 306. Router 306 receives IP packets through network access port ‘1’ 308, examines the destination IP address contained in IP datagrams generated by IP layer 318, and routes IP packets through network access port ‘2’ 310 to the designated destination IP address. In this same embodiment, participating physical host ‘2’ 304 receives incoming IP packets through its associated multi-layer communications protocol stack to implement virtual machine 438, comprising, but not limited to virtual machine autorun scripts 428, and payload 429 that includes operating systems 430, other virtual machines 432, applications 434, and data 436. Once carrier virtual machine 426 has completed migration to participating physical host ‘2’ 304 as virtual machine 438, carrier virtual machine 426 on participating physical host ‘1’ 302 can be destroyed (if required by security policies).

In an embodiment of the invention, virtual machine Autorun scripts 428 can be initiated per virtual machine initiation and may comprise, but is not limited to, central policy updates, heartbeat and timeout monitors, and security checks including but not limited to VM group, individual VM, VM packet, etc. as described in more detail hereinbelow.

In an embodiment of the invention, carrier virtual machine 426 can set datagram header fields for different router implementations, including but not limited to, IP, fibre channel, Infiniband, thereby allowing carrier virtual machine 426 to traverse heterogeneous network environments.

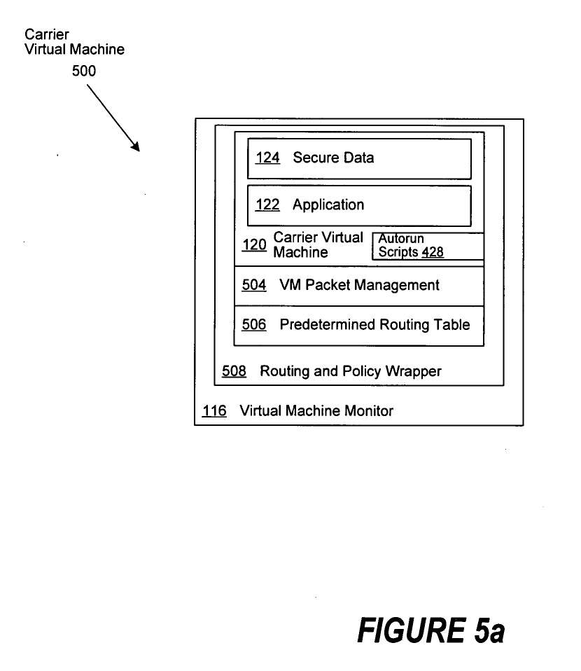

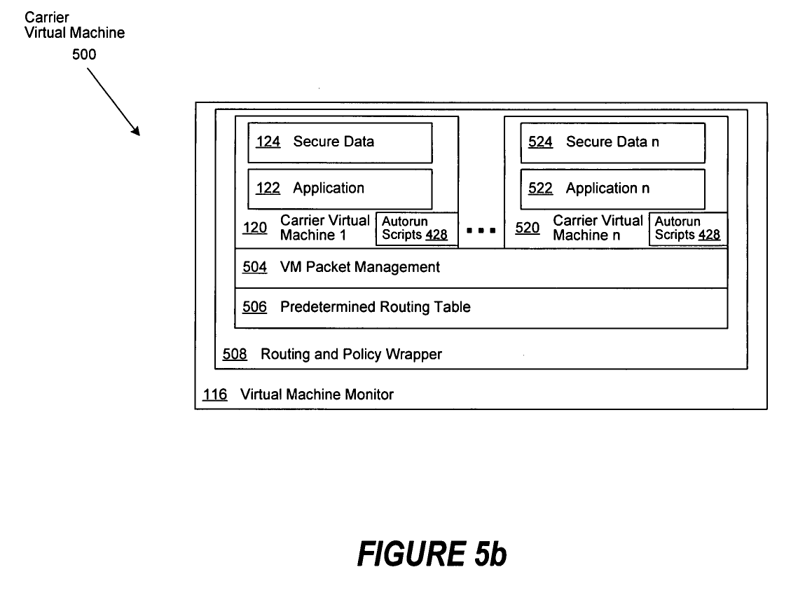

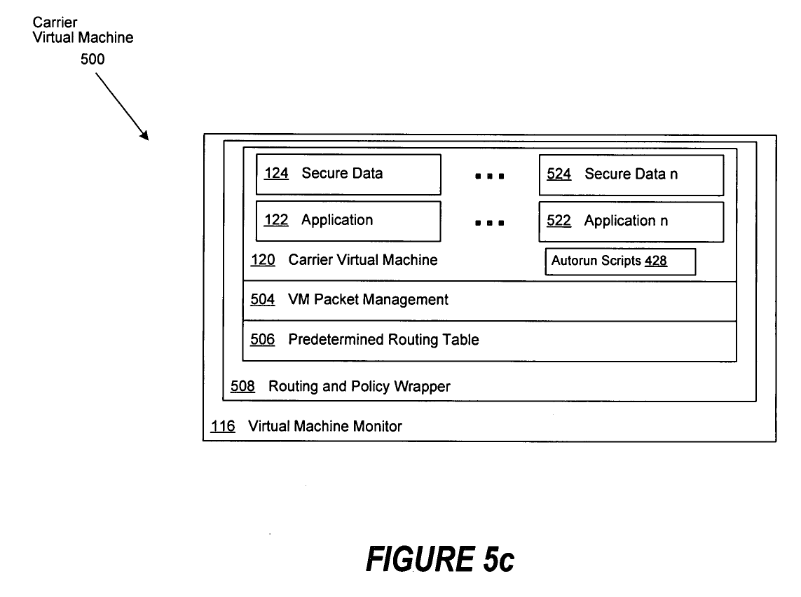

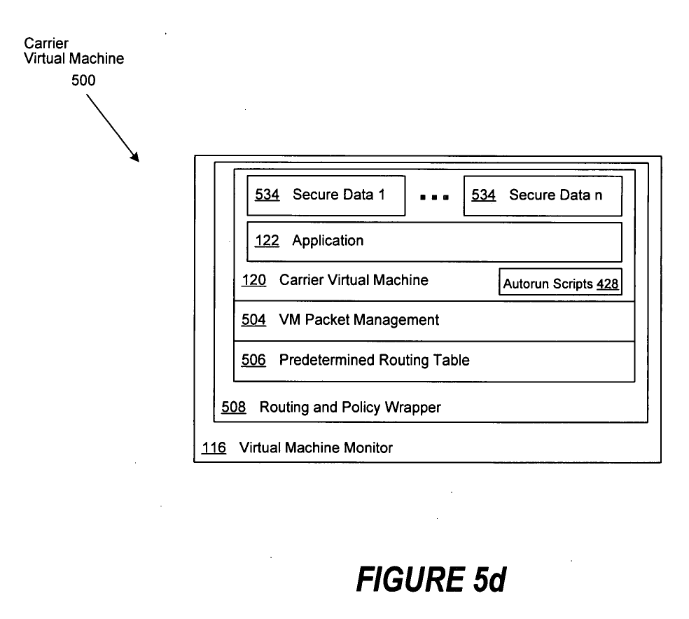

FIG. 5a is a generalized illustration of a carrier virtual machine 200 that can be used to implement the system and method of the present invention. In FIG. 2a, application 122 and/or secure data 124 are encapsulated by carrier virtual machine 120. Carrier virtual machine 120 is associated with VM packet management 504 and predetermined routing table 506. In an embodiment of the invention, application 122 may comprise one or more software programs that can execute within carrier virtual machine 120. Secure data 124 may be associated with application 122 or may be independently encapsulated by carrier virtual machine 120, and may employ encryption or cryptographic means to provide additional security and protection against malicious attack.

In an embodiment of the invention, virtual machine (VM) packet management 504 comprises parameters that may include, but are not limited to, time-to-live (TTL), security mechanisms such as access control lists (ACLs), usage policies, directory roles, etc. for carrier virtual machine 120, and by extension, application 122 and/or secure data 124, individually or in combination. For example, VM packet management 504 may control the flexibility of hardware and/or software access for VM network endpoints and/or intermediate routing hops. As another example, the VM packet management 504 may instantiate quarantining of all VM packets, a group of packets, a single VM, subpackets within a VM between network endpoints, or at a predetermined intermediary network point. VM packet management 504 may also manage access to carrier virtual machine payloads by security groups, individual access, subdivided individual access, and MIME-like subdivision of a VM-encapsulated payload, thereby providing the ability to carry many secured payloads.

In an embodiment of the invention, predetermined routing table 506 manages originating and terminating network addresses. In an embodiment of the invention, predetermined routing table 506 can translate between physical network addresses and virtual network addresses as typically implemented in a virtual network (VNET) whether the VNET is implemented on a Local Area Network (LAN), a Wide Area Network (WAN) such as the Internet or a corporate intranet, or a combination of public and/or private network technologies and protocols. In an embodiment of the invention, predetermined routing table 506 may also include routing, event tree, and security information regarding individual physical or virtual network hops between two endpoints.

Routing and policy wrapper 508 can provide network routing and policy enforcement prior to VM packet events. Similar to just-in-time and late binding, carrier virtual machines can reference routing and policy wrapper 508 prior to events such as, but not limited to, routing, cloning, broadcasting, subdividing, merging, and predetermined or scheduled configuration revisions to routes, time-to-live (TTL), encryption, etc. Furthermore, routing and policy wrapper 508 may provide additional control over hardware functionality, such as but not limited to, copying or printing secured data encapsulated by carrier virtual machine 120.

Virtual machine monitor 116 encapsulates the software state of carrier virtual machine 120, including application 122 and/or secure data 124, and can map and remap carrier virtual machine 120 to available hardware resources as it is migrated across different physical machines. Virtual machine monitor 116 can provide a uniform view of underlying hardware, making different physical machines with different I/O subsystems appear the same. Furthermore, virtual machine monitor 116 can interact with routing and policy wrapper 508 to access information contained by predetermined routing table 506 and/or VM packet management 504 to facilitate the secure transfer of data across a network environment.

FIG. 5b is a generalized illustration of a plurality of carrier virtual machines 500 that can be used to implement the system and method of the present invention. In FIG. 2b, application 122 and/or secure data 124 are encapsulated by a plurality of carrier virtual machines 120, 220. Each carrier virtual machine 120, 520 is associated with VM packet management 504 and predetermined routing table 506. In an embodiment of the invention, application 122 may comprise one or more software programs that can execute within carrier virtual machines 120, 520. Secure data 124 may be associated with application 122 or may be independently encapsulated by carrier virtual machines 120, 520 and may employ encryption or cryptographic means to provide additional security and protection against malicious attack.

In an embodiment of the invention, virtual machine (VM) packet management 204 comprises parameters that may include, but are not limited to, time-to-live (TTL), security mechanisms such as access control lists (ACLs), usage policies, directory roles, etc. for each carrier virtual machine 120, 520, and by extension, application 122 and/or secure data 124, individually or in combination. For example, VM packet management 504 may control the flexibility of hardware and/or software access for VM network endpoints and/or intermediate routing hops. As another example, the VM packet management 504 may instantiate quarantining of all VM packets, a group of packets, one or more VMs, subpackets within a VM between network endpoints, or at a predetermined intermediary network point. VM packet management 504 may also manage access to carrier virtual machine payloads by security groups, individual access, subdivided individual access, and MIME-like subdivision of a VM-encapsulated payload, thereby providing the ability to carry many secured payloads. In an embodiment of the invention, VM packet management 504 may implement individual or combinations of these functionalities on one or more of a plurality of carrier virtual machines 120, 520, and by extension, application 122 and/or secure data 124, individually or in combination.

In an embodiment of the invention, predetermined routing table 506 manages originating and terminating network addresses. In an embodiment of the invention, predetermined routing table 506 can translate between physical network addresses and virtual network addresses as typically implemented in a virtual network (VNET) whether the VNET is implemented on a Local Area Network (LAN), a Wide Area Network (WAN) such as the Internet or a corporate intranet, or a combination of public and/or private network technologies and protocols. In an embodiment of the invention, predetermined routing table 506 may also include routing, event tree, and security information regarding individual physical or virtual network hops between two endpoints. In an embodiment of the invention, individual or combinations of event tree and security functionalities may be implemented on one or more of a plurality of carrier virtual machines 120, 520.

Routing and policy wrapper 508 can provide network routing and policy enforcement prior to VM packet events. Similar to just-in-time and late binding, carrier virtual machines 120, 520 can reference routing and policy wrapper 508 prior to events such as, but not limited to, routing, cloning, broadcasting, subdividing, merging, and predetermined or scheduled configuration revisions to routes, time-to-live (TTL), encryption, etc. Furthermore, routing and policy wrapper 508 may provide additional control over hardware functionality, such as but not limited to, copying or printing secured data encapsulated by one or more of a plurality of carrier virtual machines 120, 520. In an embodiment of the invention, routing and policy wrapper 508 may interact with one or more carrier virtual machines 120, 520, individually or in combination, prior to events such as, but not limited to, routing, cloning, broadcasting, subdividing, merging, and predetermined or scheduled configuration revisions to routes, time-to-live (TTL), encryption, etc.

Virtual machine monitor 116 encapsulates the software state of one or more carrier virtual machines 120, 520, including application 122 and/or secure data 124, and can map and remap a plurality of carrier virtual machines 120, 520 to available hardware resources as it is migrated across different physical machines. Virtual machine monitor 116 can provide a uniform view of underlying hardware, making different physical machines with different I/O subsystems appear the same. Furthermore, virtual machine monitor 116 can interact with routing and policy wrapper 508 to access information contained by predetermined routing table 506 and/or VM packet management 504 to facilitate the secure transfer of data across a network environment by a plurality of carrier virtual machines 120, 520.

FIG. 5c is a generalized illustration of a carrier virtual machine 500 that can be used to implement the system and method of the present invention as a single carrier virtual machine 120 encapsulating a plurality of applications 122, 522 and/or secure sets of data 124, 524. Carrier virtual machine 120 is associated with VM packet management 504 and predetermined routing table 506. In an embodiment of the invention, applications 122, 522 may comprise one or more software programs that can execute within carrier virtual machine 120. Secure sets of data 124, 524 may be associated with applications 122, 522.or may be independently encapsulated by carrier virtual machine 120, and may employ encryption or cryptographic means to provide additional security and protection against malicious attack.

In an embodiment of the invention, virtual machine (VM) packet management 504 comprises parameters that may include, but are not limited to, time-to-live (TTL), security mechanisms such as access control lists (ACLs), usage policies, directory roles, etc. for carrier virtual machine 120, and by extension, one or more applications 122, 522 and/or sets of secure data 124, 524, individually or in combination. For example, VM packet management 504 may control the flexibility of hardware and/or software access for VM network endpoints and/or intermediate routing hops. As another example, the VM packet management 504 may instantiate quarantining of all VM packets, a group of packets, a single VM, subpackets within a VM between network endpoints, or at a predetermined intermediary network point. VM packet management 504 may also manage access to one or more of a plurality of carrier virtual machine payloads by security groups, individual access, subdivided individual access, and MIME-like subdivision of a VM-encapsulated payload, thereby providing the ability to carry many secured payloads. In an embodiment of the invention, VM packet management 504 may implement individual or combinations of these functionalities on carrier virtual machine 120, and by extension, one or more applications 122, 522 and/or one or more sets of secure data 124, 524.

In an embodiment of the invention, predetermined routing table 506 manages originating and terminating network addresses. In an embodiment of the invention, predetermined routing table 506 can translate between physical network addresses and virtual network addresses as typically implemented in a virtual network (VNET) whether the VNET is implemented on a Local Area Network (LAN), a Wide Area Network (WAN) such as the Internet or a corporate intranet, or a combination of public and/or private network technologies and protocols. In an embodiment of the invention, predetermined routing table 506 may also include routing, event tree, and security information regarding individual physical or virtual network hops between two endpoints. In an embodiment of the invention, individual or combinations of event tree and security functionalities may be implemented on one or more applications 122, 522 and/or one or more sets of secure data 124, 524.

Routing and policy wrapper 508 can provide network routing and policy enforcement prior to VM packet events. Similar to just-in-time and late binding, carrier virtual machine 120 can reference routing and policy wrapper 508 prior to events such as, but not limited to, routing, cloning, broadcasting, subdividing, merging, and predetermined or scheduled configuration revisions to routes, time-to-live (TTL), encryption, etc. for one or more applications 122, 522 and/or one or more sets of secure data 124, 524. Furthermore, routing and policy wrapper 508 may provide additional control over hardware functionality, such as but not limited to, copying or printing one or more sets of secured data 124, 524 encapsulated by carrier virtual machine 120. In an embodiment of the invention, routing and policy wrapper 508 may interact with carrier virtual machine 120, and by extension, one or more applications 122, 522 and/or sets of secure data 124, 524, individually or in combination, prior to events such as, but not limited to, routing, cloning, broadcasting, subdividing, merging, and predetermined or scheduled configuration revisions to routes, time-to-live (TTL), encryption, etc.

Virtual machine monitor 116 encapsulates the software state of carrier virtual machine 120, including one or more applications 122, 522 and/or one or more sets of secure data 124, 524, and can map and remap carrier virtual machine 120 to available hardware resources as it is migrated across different physical machines. Virtual machine monitor 116 can provide a uniform view of underlying hardware, making different physical machines with different I/O subsystems appear the same. Furthermore, virtual machine monitor 116 can interact with routing and policy wrapper 508 to access information contained by predetermined routing table 506 and/or VM packet management 504 to facilitate the secure transfer of a plurality of applications 122, 522, and/or a plurality of secure sets of data 124, 524, across a network environment by carrier virtual machine 120.

FIG. 2d is a generalized illustration of a carrier virtual machine 500 that can be used to implement the system and method of the present invention as a single carrier virtual machine 120 encapsulating application 122 and/or a plurality if secure sets of data 124, 524. Carrier virtual machine 120 is associated with VM packet management 504 and predetermined routing table 506. In an embodiment of the invention, application 122 may comprise one or more software programs that can execute within carrier virtual machine 120. Secure sets of data 124, 524 may be associated with application 122 or may be independently encapsulated by carrier virtual machine 120, and may employ encryption or cryptographic means to provide additional security and protection against malicious attack.

In an embodiment of the invention, virtual machine (VM) packet management 504 comprises parameters that may include, but are not limited to, time-to-live (TTL), security mechanisms such as access control lists (ACLs), usage policies, directory roles, etc. for carrier virtual machine 120, and by extension application 122 and/or sets of secure data 124, 524, individually or in combination. For example, VM packet management 504 may control the flexibility of hardware and/or software access for VM network endpoints and/or intermediate routing hops. As another example, the VM packet management 204 may instantiate quarantining of all VM packets, a group of packets, a single VM, or subpackets within a VM between network endpoints, or at a predetermined intermediary network point. VM packet management 504 may also manage access to one or more of a plurality of carrier virtual machine payloads by security groups, individual access, subdivided individual access, and MIME-like subdivision of a VM-encapsulated payload, thereby providing the ability to carry many secured payloads. In an embodiment of the invention, VM packet management 504 may implement individual or combinations of these functionalities on carrier virtual machine 120, and by extension, application 122 and/or one or more sets of secure data 124, 524.

In an embodiment of the invention, predetermined routing table 506 manages originating and terminating network addresses. In an embodiment of the invention, predetermined routing table 506 can translate between physical network addresses and virtual network addresses as typically implemented in a virtual network (VNET) whether the VNET is implemented on a Local Area Network (LAN), a Wide Area Network (WAN) such as the Internet or a corporate intranet, or a combination of public and/or private network technologies and protocols. In an embodiment of the invention, predetermined routing table 506 may also include routing, event tree, and security information regarding individual physical or virtual network hops between two endpoints. In an embodiment of the invention, individual or combinations of event tree and security functionalities may be implemented on carrier virtual machine 120, and by extension, application 122 and/or one or more sets of secure data 124, 524.

Routing and policy wrapper 508 can provide network routing and policy enforcement prior to VM packet events. Similar to just-in-time and late binding, carrier virtual machine 120 can reference routing and policy wrapper 508 prior to events such as, but not limited to, routing, cloning, broadcasting, subdividing, merging, and predetermined or scheduled configuration revisions to routes, time-to-live (TTL), encryption, etc. for application 122 and/or one or more sets of secure data 124, 524. Furthermore, routing and policy wrapper 508 may provide additional control over hardware functionality, such as but not limited to, copying or printing one or more sets of secured data 124, 524 encapsulated by carrier virtual machine 120. In an embodiment of the invention, routing and policy wrapper 508 may interact with carrier virtual machine 120, and by extension, application 122 and/or sets of secure data 124, 524, individually or in combination, prior to events such as, but not limited to, routing, cloning, broadcasting, subdividing, merging, and predetermined or scheduled configuration revisions to routes, time-to-live (TTL), encryption, etc.

Virtual machine monitor 116 encapsulates the software state of carrier virtual machine 120, including application 122 and/or one or more sets of secure data 124, 524, and can map and remap carrier virtual machine 120 to available hardware resources as it is migrated across different physical machines. Virtual machine monitor 116 can provide a uniform view of underlying hardware, making different physical machines with different I/O subsystems appear the same. Furthermore, virtual machine monitor 116 can interact with routing and policy wrapper 508 to access information contained by predetermined routing table 506 and/or VM packet management 504 to facilitate the secure transfer of application 122 and/or a plurality of secure sets of data 124, 524, across a network environment by carrier virtual machine 120.

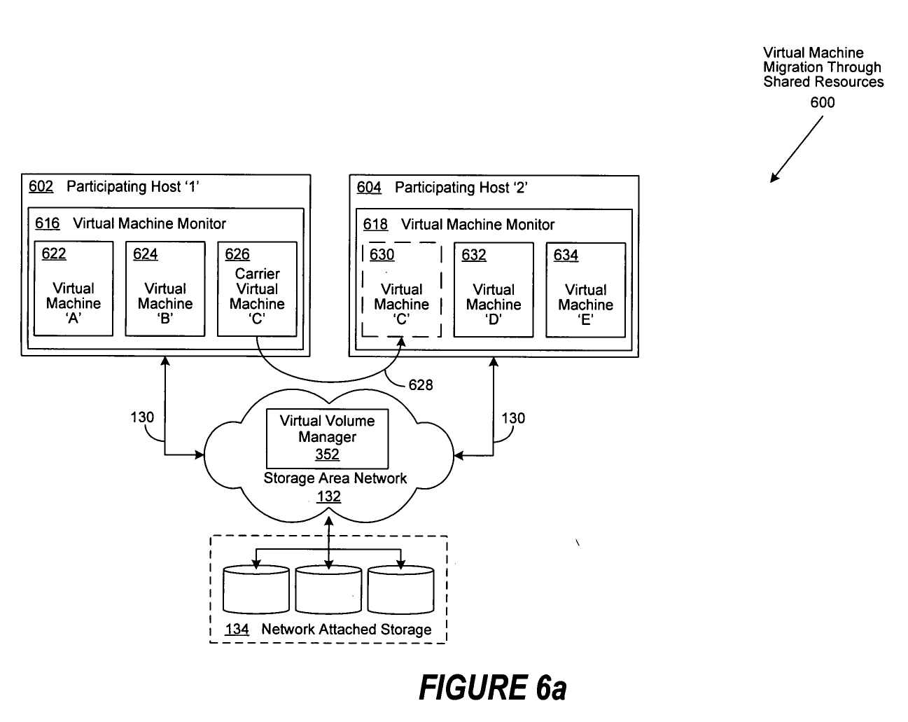

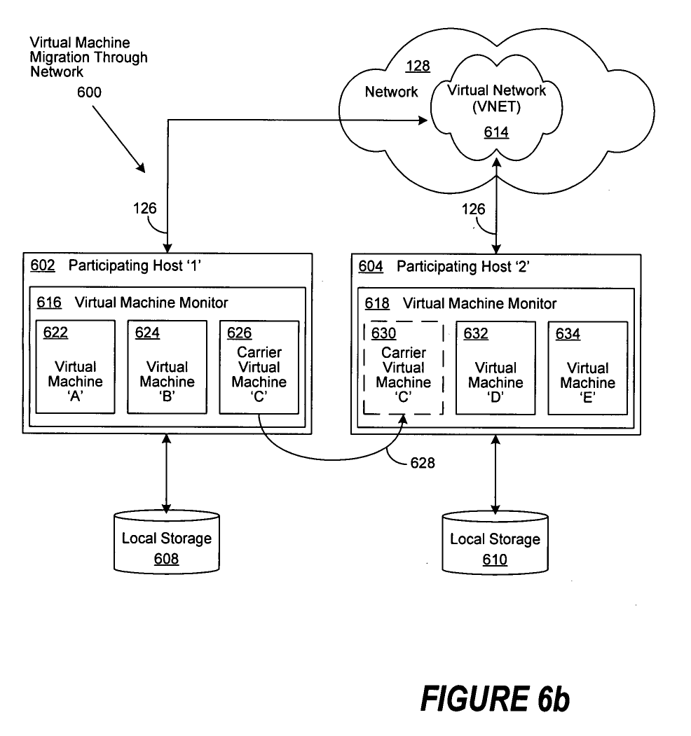

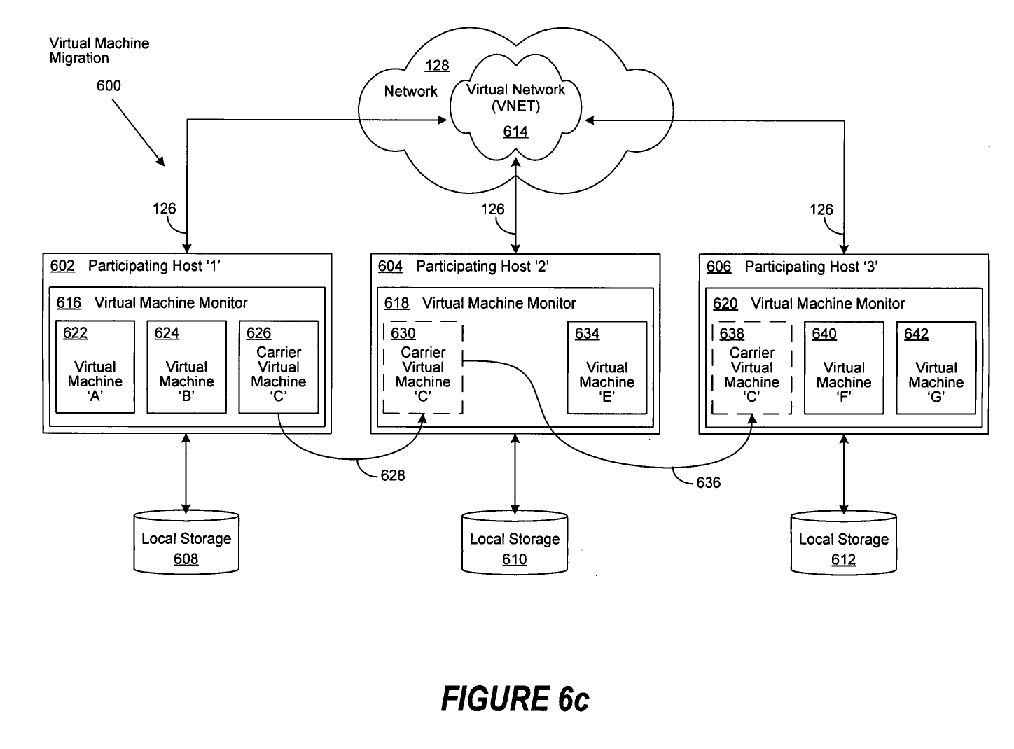

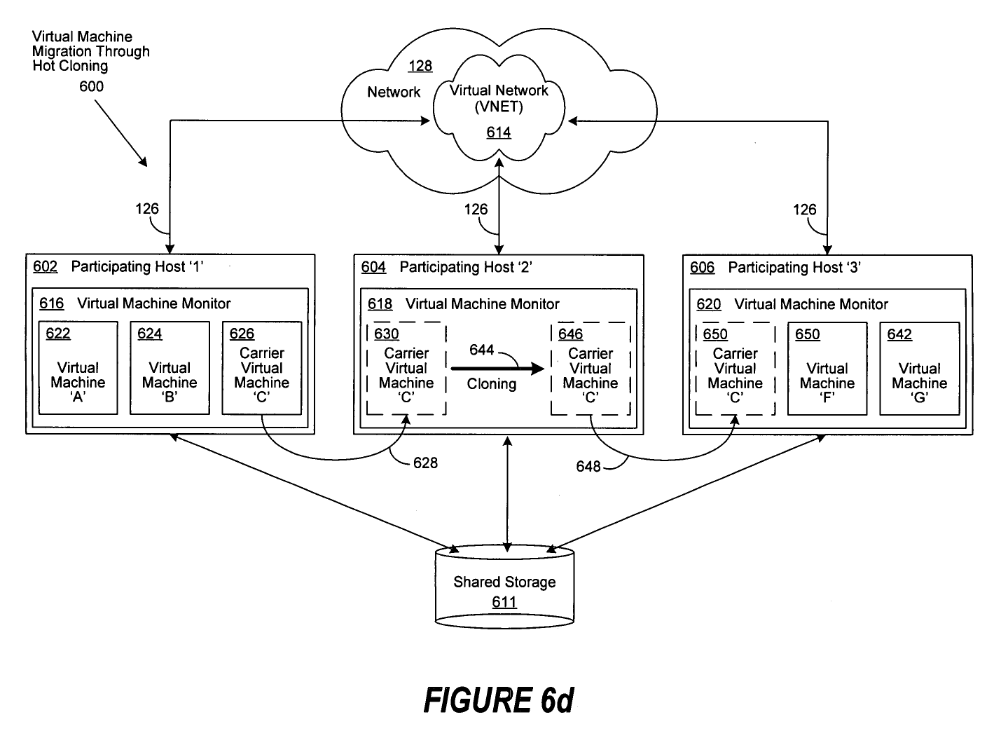

FIG. 6a is a generalized illustration of carrier virtual machines that can be used to implement the system and method of the present invention through shared resources comprising storage area network 132. In FIG. 6a, participating physical host ‘1’ comprises virtual machine monitor 616 comprising virtual machine ‘A’ 622, virtual machine ‘B’ 624, and virtual machine ‘C’ 626. Participating physical host ‘2’ comprises virtual machine monitor 618 comprising virtual machine ‘D’ 632 and virtual machine ‘E’ 624. Participating physical host ‘1’ and participating physical host ‘2’ share network attached storage 134 resources by coupling to storage area network 132 through a suitable storage peripheral connection 130, such as but not limited to fibrechannel, High-Performance Peripheral Interface (HIPPI), etc.

In an embodiment of the invention, virtual volume manager (VVM) 652 can logically aggregate a pool of network attached physical storage devices 134 implemented on storage area network 132 to create and manage virtual storage devices (VSDs), which can be coupled to a plurality of virtual machines implemented on one or more participating physical hosts. In this same embodiment, virtual machine monitors 616, 618 can interact with virtual volume manager 652 to provide location transparency of the physical location of data. In an embodiment of the invention, virtual machine monitor 616 residing on participating physical host ‘1’ 604 interacts with virtual machine monitor 618 residing on participating physical host ‘2’ 604 to migrate 628 carrier virtual machine ‘C’ 626 from participating physical host ‘1’ 604 to participating physical host ‘2’ 604.

In an embodiment of the invention, a user specifies payload residing within VSDs implemented by VVM 652 that is to be secured and then transferred to a predetermined participating destination host (e.g., participating host ‘2’). A carrier virtual machine ‘C’ 626, residing on participating physical host ‘1’ 604, is created and VM routing tables are created which may also include routing, event tree, and security information regarding individual physical or virtual network hops between two endpoints as described in more detail hereinabove. A migration connection 628 is then established with participating physical host ‘2’ 604 to accept a request for transferring data.

The identified data to be secured is then encrypted and encapsulated into carrier virtual machine ‘C’ 626. In an embodiment of the invention, time to live (TTL) attributes may be set for carrier virtual machine ‘C’ 626. In this embodiment, if carrier virtual machine ‘C’ 626 fails to migrate to its next predetermined network hop or fails to execute assigned task at the host within its TTL attributes, one or more predetermined actions may be implemented to take place. For example, the sender of the carrier virtual machine ‘C’ 626 may be notified. As another example, carrier virtual machine ‘C’ 626 may terminate, thereby destroying itself and any encapsulated data it may be carrying. As yet another example, it may send a request to its originator for a TTL extension (e.g., network congestion is delaying its migration) or to be rerouted (e.g., through less congested network routes). Many such actions are possible.

Once identified data is encrypted, carrier virtual machine ‘C’ 626 is created, and TTL attributes are set, carrier virtual machine ‘C’ 626 is migrated to participating host ‘2’ 604. In this same embodiment, as carrier virtual machine ‘C’ 626 is migrated, virtual volume manager 652 can migrate its associated VSDs with it. Note that only the VSD's access points migrate and the physical data itself is not moved. It will be apparent to those of skill in the art that large amounts of data can be passed across virtual machines by changing VSD mappings in this manner. Once migration 628 is completed, carrier virtual machine ‘C’ 626 becomes virtual machine “C” 630 on participating physical host 604, and carrier virtual machine ‘C’ 626, residing on participating physical host ‘1’ 604 is terminated. Once secured data has been successfully written to local storage 610 it is decrypted and the originator can be notified that it has successfully reached its destination. In case of failure, the process can be repeated at the originator's discretion.

FIG. 6b is a generalized illustration of carrier virtual machines that can be used to implement the system and method of the present invention through a virtual network (VNET) 6614. In FIG. 6b, participating physical host ‘1’ comprises virtual machine monitor 616 comprising virtual machine ‘A’ 622, virtual machine ‘B’ 624, virtual machine ‘C’ 626, and local physical storage 608. Participating physical host ‘2’ comprises virtual machine monitor 618 comprising virtual machine ‘D’ 632, virtual machine ‘E’ 634, and local physical storage 610. Participating physical host ‘1’ and participating physical host ‘2’ are coupled through network connections 126 to network 128, which can be but is not limited to, a local area network (LAN), a wide area network (WAN), or any combination of communication technologies and/or protocols that may be required to transport data packets between one or more information handling systems. Virtual network (VNET) 614 is a virtual private network (VPN) that implements a virtual local area network (VLAN) that in turn is implemented on a physical network 128 such as a Local Area Network (LAN), a Wide Area Network (WAN) such as the Internet or a corporate intranet, or a combination of public and/or private network technologies and protocols.

Skilled practitioners of the art will be aware that a VNET is typically established at layer 2 of the OSI network model. Through the use of layer 2 tunneling and by translating between physical and virtual network addresses, a VNET can create the illusion of a local area network, even when physical network resources are spread over a wide area. Since a VNET is established at layer 2, a virtual machine can be migrated from site to site without changing its presence, as it keeps the same media access control (MAC) and IP addresses, network routes, etc. Furthermore, since VNETs are decoupled from the underlying network topology, they are able to maintain network connectivity in its original form during/after virtual machine migration.

Additionally, VNETs can provide security comparable to a hardware-based VLAN through the use or the IPsec Encapsulated Security Payload protocol. IPsec can be used to encapsulate VNET EtherIP packets to provide message authentication, thereby ensuring that only authorized entities within the virtual network can send data. In addition, IPsec can employ encryption to ensure that only the intended recipient can read data conveyed by IPsec packets.

In an embodiment of the invention, a user specifies data residing within local storage 608 that is to be secured and then transferred to a predetermined participating destination host (e.g., participating host ‘2’). A carrier virtual machine ‘C’ 626, residing on participating physical host ‘1’ 604, is created and VM routing tables are created which may also include routing, event tree, and security information regarding individual physical or virtual network hops between two endpoints as described in more detail hereinabove. A migration connection 628 is then established with participating physical host ‘2’ 604 to accept a request for transferring data.

The identified data to be secured in local storage 608 is then encrypted and encapsulated into carrier virtual machine ‘C’ 626. In an embodiment of the invention, time to live (TTL) attributes may be set for carrier virtual machine ‘C’ 626. In this embodiment, if carrier virtual machine ‘C’ 626 fails to migrate to its next predetermined network hop or fails to execute assigned task at the host within its TTL attributes, one or more predetermined actions may be implemented to take place. For example, the sender of the carrier virtual machine ‘C’ 626 may be notified. As another example, carrier virtual machine ‘C’ 626 may terminate, thereby destroying itself and any encapsulated data it may be carrying. As yet another example, it may send a request to its originator for a TTL extension (e.g., network congestion is delaying its migration) or to be rerouted (e.g., through less congested network routes). Many such actions are possible.

Once identified data is encrypted, carrier virtual machine ‘C’ 626 is created, and TTL attributes are set, carrier virtual machine ‘C’ 626 is migrated to participating host ‘2’ 604 through virtual network 614, which is implemented on network 128 as described in more detail hereinabove. As migration progresses, secure data from local storage 608 is written to local storage 610. Once migration 628 is completed, carrier virtual machine ‘C’ 626 becomes virtual machine ‘C’ 630 on participating physical host ‘2’ 604, and carrier virtual machine ‘C’ 626, residing on participating physical host ‘1’ 604 is terminated. In an embodiment of the invention additional security can be achieved by terminating virtual network 614 once carrier virtual machine ‘C’ 626, previously residing on participating physical host ‘1’ 604 is terminated. Once secured payload has been successfully written to local storage 610 it is decrypted and the originator can be notified that it has successfully reached its destination. In case of failure, the process can be repeated at the originator's discretion.

FIG. 6c is a generalized illustration of carrier virtual machines that can be used to implement the system and method of the present invention through multiple network hops across a virtual network (VNET) 614. In FIG. 6c, participating physical host ‘1’ comprises virtual machine monitor 616 comprising virtual machine ‘A’ 622, virtual machine ‘B’ 624, virtual machine ‘C’ 626, and local physical storage 608. Participating physical host ‘2’ comprises virtual machine monitor 618 comprising virtual machine ‘D’ 632, virtual machine ‘E’ 634, and local physical storage 610. Participating physical host ‘3’ 606 comprises virtual machine monitor 620 comprising virtual machine ‘F’ 640, virtual machine ‘G’ 642, and local physical storage 612. Participating physical host ‘1’ 602, participating physical host ‘2’ 604 and participating physical host ‘3’ 606 are coupled through network connections 126 to virtual network (VNET) 614, implemented on network 128 as described in more detail hereinabove.

In an embodiment of the invention, a user specifies payload residing within local storage 608 that is to be secured and then transferred to a predetermined participating destination host (e.g., participating host ‘3’ 616) through participating host ‘2’ 618, performing set tasks at each host. A carrier virtual machine ‘C’ 626, residing on participating physical host ‘1’ 604, is created and VM routing tables are created which may also include routing, event tree, and security information regarding individual physical or virtual network hops between two endpoints as described in more detail hereinabove. A migration connection 628 is then established with participating physical host ‘2’ 604 to accept a request for transferring data.

The identified data to be secured in local storage 608 is then encrypted and encapsulated into carrier virtual machine ‘C’ 626. In an embodiment of the invention, time to live (TTL) attributes may be set for carrier virtual machine ‘C’ 626. In this embodiment, if carrier virtual machine ‘C’ 626 fails to migrate to its next predetermined network hop or execute assigned task at the host within its TTL attributes, one or more predetermined actions may be implemented to take place. For example, the sender of the carrier virtual machine ‘C’ 626 may be notified. As another example, carrier virtual machine ‘C’ 626 may terminate, thereby destroying itself and any encapsulated data it may be carrying. As yet another example, it may send a request to its originator for a TTL extension (e.g., network congestion is delaying its migration) or to be rerouted (e.g., through less congested network routes). Many such actions are possible.

Once identified payload is encrypted, carrier virtual machine ‘C’ 626 is created, and TTL attributes are set, carrier virtual machine ‘C’ 626 is migrated to participating host ‘2’ 604 through virtual network 614, which is implemented on network 128 as described in more detail hereinabove. As migration progresses, secure payload from local storage 608 is written to local storage 610. Once migration 628 is completed, carrier virtual machine ‘C’ 626 becomes virtual machine ‘C’ 630 on participating physical host 604, and carrier virtual machine ‘C’ 626, residing on participating physical host ‘1’ 604 is terminated. In an embodiment of the invention additional security can be achieved by terminating virtual network 614 once carrier virtual machine ‘C’ 626, previously residing on participating physical host ‘1’ 604 is terminated.

A migration connection 636 is then established with participating physical host ‘3’ 616 to accept a request for transferring data. The identified payload to be secured in local storage 610 is then encrypted and encapsulated into carrier virtual machine 630. In an embodiment of the invention, time to live (TTL) attributes may be set for carrier virtual machine 630. In this embodiment, if carrier virtual machine 630 fails to migrate to its next predetermined network hop or execute assigned task the host within its TTL attributes, one or more predetermined actions may be implemented to take place. For example, the sender of the carrier virtual machine 630 may be notified. As another example, carrier virtual machine 630 may terminate, thereby destroying itself and any encapsulated data it may be carrying. As yet another example, it may send a request to its originator for a TTL extension (e.g., network congestion is delaying its migration) or to be rerouted (e.g., through less congested network routes). Many such actions are possible.

Once identified payload is encrypted, carrier virtual machine 630 is created, and TTL attributes are set, carrier virtual machine 630 is migrated to participating host ‘3’ 616 through virtual network 614, which is implemented on network 128 as described in more detail hereinabove. As migration progresses, secure payload from local storage 610 is written to local storage 612. Once migration 636 is completed, carrier virtual machine ‘C’ 630 becomes virtual machine ‘C’ 638 on participating physical host ‘3’ 616, and carrier virtual machine ‘C’ 630, residing on participating physical host ‘1’ 604 is terminated. In an embodiment of the invention additional security can be achieved by terminating virtual network 614 once carrier virtual machine ‘C’ 630, previously residing on participating physical host ‘1’ 604 is terminated.

In an embodiment of the invention, additional identified payload to be secured, residing in local storage 610 is appended to secured data migrated from local storage 608 before it is migrated to participating physical host ‘3’ 616 by carrier virtual machine ‘C’ 630. In an embodiment of the invention, once secured payload from local storage 608 is migrated to participating physical host ‘2’ 604 and written to local storage 610, it may be modified before it is migrated to participating physical host ‘3’ 616 by carrier virtual machine ‘C’ 630. Many such variations are possible. Once secured payload has been successfully written to local storage 612 it is decrypted and the originator can be notified that it has successfully reached its destination. In case of failure, the process can be repeated at the originator's discretion.

FIG. 6d is a generalized illustration of carrier virtual machines that can be used to implement the system and method of the present invention using “hot cloning” at multiple network hops across a virtual network (VNET) 614. In FIG. 6d, participating physical host ‘1’ comprises virtual machine monitor 616 comprising virtual machine ‘A’ 622, virtual machine ‘B’ 624, and virtual machine ‘C’ 626. Participating physical host ‘2’ comprises virtual machine monitor 618 and shared physical storage 611 that is used in the process of cloning carrier virtual machine 646 from carrier virtual machine 630. Participating physical host ‘3’ comprises virtual machine monitor 620 comprising virtual machine ‘F’ 640, and virtual machine ‘G’ 642. Participating physical host ‘1’, participating physical host ‘2’ and participating physical host ‘3’ are coupled through network connections 126 to virtual network (VNET) 614, implemented on network 128 as described in more detail hereinabove.

In an embodiment of the invention, a user specifies payload residing within local storage 608 that is to be secured and then transferred to a predetermined participating destination host (e.g., participating host ‘3’ 616) through participating host ‘2’ 618, performing set tasks at each host. A carrier virtual machine ‘C’ 626, residing on participating physical host ‘1’ 604, is created and VM routing tables are created which may also include routing, event tree, and security information regarding individual physical or virtual network hops between two endpoints as described in more detail hereinabove.

A migration connection 628 is then established with participating physical host ‘2’ 604 to accept a request for transferring data. The identified data to be secured in local storage 608 is then encrypted and encapsulated into carrier virtual machine ‘C’ 626. In an embodiment of the invention, time to live (TTL) attributes may be set for carrier virtual machine ‘C’ 626. In this embodiment, if carrier virtual machine ‘C’ 626 fails to migrate to its next predetermined network hop or execute assigned task at the host within its TTL attributes, one or more predetermined actions may be implemented to take place. For example, the sender of the carrier virtual machine ‘C’ 626 may be notified. As another example, carrier virtual machine ‘C’ 626 may terminate, thereby destroying itself and any encapsulated data it may be carrying. As yet another example, it may send a request to its originator for a TTL extension (e.g., network congestion is delaying its migration) or to be rerouted (e.g., through less congested network routes). Many such actions are possible.

Once identified data is encrypted, carrier virtual machine ‘C’ 626 is created, and TTL attributes are set, carrier virtual machine ‘C’ 626 is migrated to participating host ‘2’ 604 through virtual network 614, which is implemented on network 128 as described in more detail hereinabove. In an embodiment of the invention, as carrier virtual machine ‘ C’626 is migrated to participating physical host ‘2’ 604, “hot cloning” 644 is initiated to create a clone of carrier virtual machine ‘C’ 646. Once migration of carrier virtual machine ‘C’626 to participating physical host ‘2’ 604 and “hot cloning” 644 is complete, carrier virtual machine ‘C’ 646 is migrated 648 to participating host ‘3’ 616 through virtual network 614, which is implemented on network 128 as described in more detail hereinabove.

Once migration 648 is completed, carrier virtual machine ‘C’ 646 becomes virtual machine ‘C’ 650 on participating physical host 604, and carrier virtual machine ‘C’ 646, residing on participating physical host ‘2’ 604 is terminated. In an embodiment of the invention additional security can be achieved by terminating virtual network 614 once carrier virtual machine ‘C’ 646, previously residing on participating physical host ‘2’ 604 is terminated. In case of any failure, the process can be repeated or policy based action can be taken.

Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

At a minimum, the present invention provides a system and method for the secure transfer of data by carrier virtual machines between participating physical hosts through a virtual network (VNET) implemented on one or more internal and/or external networks. Furthermore, use of the invention can provide additional security controls, comprising for example, parameters that may include, but are not limited to, time-to-live (TTL), access control lists (ACLs), usage policies, directory roles, etc. As another example, VM packets, a group of packets, a single VM, or subpackets within a VM between network endpoints, or at a predetermined intermediary network point, may be quarantined to realize further security. In addition, access to one or more of a plurality of carrier virtual machine payloads by security groups, individual access, subdivided individual access, and MIME-like subdivision of a VM-encapsulated payload may be controlled, thereby providing the carrier VM the ability to carry many secured payloads. Individual or combinations of these functionalities on carrier virtual machines, and by extension, application and/or one or more sets of secure data may be implemented.

What is claimed is:

1. A system for transferring data on a network, comprising:
a first information handling system operably connected to said network;
a first virtual machine implemented on said first information handling system, said first virtual machine comprising a payload; and
a second information handling system operably connected to said network;
wherein said first virtual machine is operable to migrate from said first information handling system to said second information handling system, thereby transporting said payload over said network.

2. The system of claim 1, wherein said payload comprises an application.

3. The system of claim 2, wherein said application comprises a software program that executes within said first virtual machine.

4. The system of claim 1, wherein said payload comprises a second virtual machine.

5. The system of claim 1, wherein said first virtual machine comprises a routing and policy wrapper.

6. The system of claim 5, wherein said second information handling system is operable to use said routing and policy wrapper to translate between physical network addresses and virtual network addresses.

7. The system of claim 6, wherein said first virtual machine has an operational lifetime governed by a time-to-live parameter.

8. The system of claim 7, further comprising an autorun script operating on said payload.

9. A method for transferring data on a network, comprising:
implementing a first virtual machine on a first information handling system operably connected to said network, said first virtual machine comprising a payload; and
migrating said first virtual machine from said first information handling system to a second information handling system, thereby transporting said payload over said network.

10. The method of claim 9, wherein said payload comprises an application.

11. The method of claim 10, wherein said application comprises a software program that executes within said first virtual machine.

12. The method of claim 9, wherein said payload comprises a second virtual machine.

13. The method of claim 9, wherein said first virtual machine comprises a routing and policy wrapper.

14. The method of claim 13, wherein said second information handling system is operable to use said routing and policy wrapper to translate between physical network addresses and virtual network addresses.

15. The method of claim 14, wherein said first virtual machine has an operational lifetime governed by a time-to-live parameter.

16. The method of claim 15, further comprising an autorun script operating on said first virtual machine.

17. A system for transferring data over a network, comprising:
a first information handling system operably connected to said network;
a first virtual machine implemented on said first information handling system, said first virtual machine comprising a payload; and
a second information handling system operably connected to said network;
wherein said first virtual machine is operable to migrate from said first information handling system to said second information handling system, thereby transporting said payload over said network; and
wherein said second information handling system is operable to generate a second virtual machine and to transfer said payload from said first virtual machine to said second virtual machine.

18. The system according to claim 17, further comprising a third information handling system, wherein said second virtual machine is operable to migrate from said second information handling system to said third information handling system.

19. The system of claim 18, wherein said first virtual machine virtual machine has an operational lifetime governed by a time-to-live parameter.

20. The system of claim 19, further comprising an autorun script operating on the host environment of said first virtual machine, thereby securing said environment.
